(19) United States
(12) Patent Application Publication
(10) Pub. No.: US 2026/0220175 A1
(43) Pub. Date: Jul. 30, 2026

(54) ADAPTIVE ARCHITECTURE FOR MULTI-MODEL AI INTEGRATION

(71) Applicant: College of the Holy Cross, Worcester, MA (US)

(72) Inventor: David Shettler, Worcester, MA (US)

(21) Appl. No.: 19/038,412

(22) Filed: Jan. 27, 2025

(51) Int. Cl. G06F 16/3332; G06F 9/50; G06F 40/205

(52) U.S. Cl. CPC G06F 16/3332; G06F 9/5083; G06F 40/205; G06F 2209/5019

(57) ABSTRACT

A method includes receiving, from a client device, a request for a model output. The request conforms to a first format associated with a first model provider, and the request includes a user input. The method also includes translating the received request into a second format associated with a second model provider and transmitting the translated request to the second model provider and receiving a response based on the translated request. The response includes the model output from a model of the second model provider. The method further includes translating the received response into the first format associated with the first model provider and providing the translated response to the client device causing the client device to present the user input and the model output.

### TECHNICAL FIELD

The present disclosure relates to adaptive architectures for multi-model artificial intelligence (AI) integration and, more particularly, to adaptive architectures for multi-model AI integration with proxy-based API emulation and scalable resource allocation.

### BACKGROUND

AI chatbot systems rely on various artificial intelligence (AI) models to process and generate human-like responses. AI models use large datasets to train algorithms that can learn patterns and relationships in language. Generative models, for example, are a kind of AI model that uses neural networks to generate responses based on a query from a user. To access these models, AI systems can use local and/or remote models. Using local models involves installing the model on a device that is associated with the chatbot application. Using remote models involves accessing the model through a remote server or cloud service. To use remote models, the chatbot application typically sends user input to the remote server, which processes the input using the model and returns the response to the chatbot application. This can be done through application programming interfaces (APIs) or software development kits (SDKs) provided by the service provider.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a diagram of an example system, in accordance with one or more embodiments.

FIG. 2 is a diagram of an example proxy service of the system of FIG. 1, in accordance with one or more embodiments.

FIG. 3 is a flow diagram of an example process for communicating with a proxy service, in accordance with one or more embodiments.

FIG. 4 is a flow diagram of an example process for proxying communication with a model provider, in accordance with one or more embodiments.

FIG. 5 is a block diagram view of an example computing system, in accordance with one or more embodiments.

### DETAILED DESCRIPTION

Given the growing body of AI models, selecting the right model for a particular task has become both an opportunity and a challenge. AI models can differ from each other in performance, cost efficiency, task suitability, etc. For instance, some models excel at generating human-like responses for conversational AI, while others are tailored for specific domains such as image or code generation. In addition to task-specific considerations, other factors may influence model preference. For example, cost may play a role, as organizations seek to balance performance with financial sustainability. Moreover, considerations such as latency, privacy, and/or ethical implications may guide model selection. For example, some applications may prioritize models that offer more moderated responses, while others may prioritize broader capabilities or reduced operational overhead. The dynamic interplay of these considerations commands flexible approaches to integrate and optimize the use of multiple AI models.

In the current landscape, accessing AI models from a variety of model providers may involve navigating a fragmented ecosystem. Each model provider may operate its own platform, offering unique APIs, licensing agreements, usage protocols, and/or the like. For organizations wanting to utilize models from multiple providers, this fragmented ecosystem creates significant operational inefficiencies. For example, organizations may maintain many separate user accounts between model providers, negotiate separate agreements between model providers, and manage distinct billing processes between model providers, any of which consume valuable time and resources. The lack of standardization in communication protocols further complicates integration, as developers must tailor their systems to the specific requirements of each model provider with whom they would like to interact. For example, each model provider may utilize their own proprietary communication protocol specifying aspects of communication such as request formatting, authentication methods, and/or the like.

This fragmented ecosystem may also affect scalability and flexibility. When a user wants to switch between model providers or integrate multiple models into a single workflow, the challenges increase. For instance, an organization might use one provider's model for general language understanding while relying on another for specialized tasks such as medical text analysis. Without a unifying interface, transitioning between these models or combining their outputs becomes cumbersome. Furthermore, real-time applications (e.g., where latency and seamless switching are prioritized) may suffer from delays and increased complexity due to these fragmented systems. As a result, the broader accessibility and usability of AI models are hindered, creating barriers for both technical and non-technical users aiming to harness the potential of these models.

Embodiments of the present disclosure include techniques for addressing the foregoing problems. The present disclosure includes a streamlined and unified architecture for accessing and utilizing advanced machine learning models from multiple providers. At its core, the architecture simplifies the traditionally fragmented process by consolidating access to these models under a single communication protocol (e.g., interface format). By leveraging a centralized system, users no longer need to interact with individual provider platforms, negotiate separate agreements, or adapt their workflows to disparate protocols. Instead, they gain access to a diverse array of models through a cohesive, unified protocol that significantly reduces administrative and technical overhead.

The architecture includes an adaptive infrastructure designed to maintain scalability, reliability, and efficiency. A shared proxy service acts as the intermediary, for example, between users and model providers, standardizing communication protocols and translating user requests into formats compatible with each provider. Additionally, a centralized storage and data management system helps maintain synchronization of user interactions, uploads, and/or outputs across the system, enabling a consistent and uninterrupted experience. The modular design of the architecture enables organizations to customize and adapt the system to their specific needs, whether that involves prioritizing certain models, maintaining compliance with privacy requirements, or optimizing for performance in specialized domains.

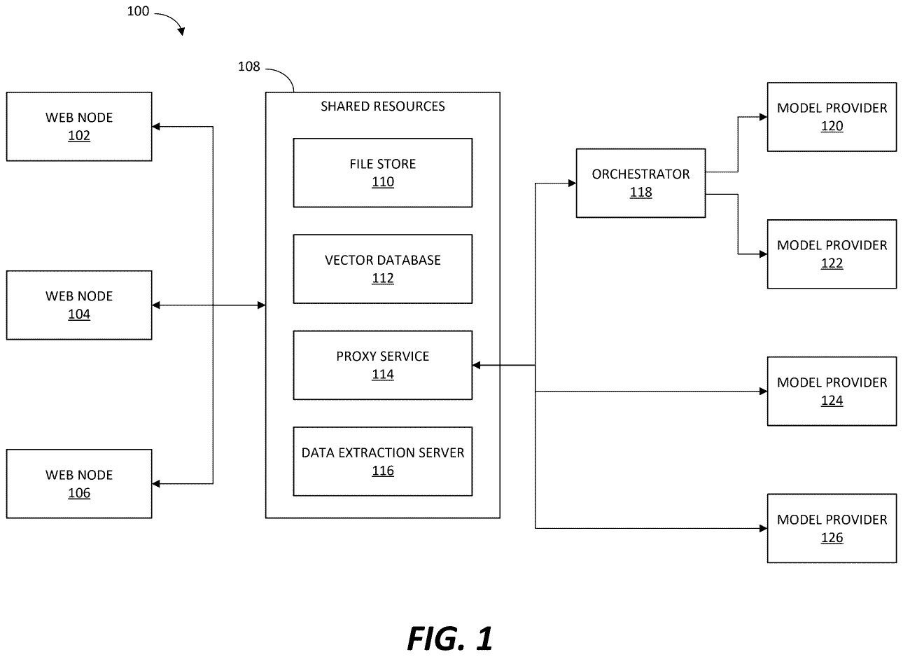

Referring now to the drawings, FIG. 1 is a diagram of an example system 100, in accordance with one or more embodiments. Not all of the depicted components may be used in all embodiments, and one or more embodiments may include additional, fewer, or different components than those shown in the figure. Variations in the arrangement and type of components may be made without departing from the spirit or scope of the claims as set forth herein.

The system 100 may include an internal network (e.g., local area network, virtual private network, etc., associated with an organization), which includes one or more web nodes 102-106 and one or more shared resources 108. A web node 102 may host a web-based application, such as Open WebUI, which allows users to input queries, manage sessions, and access features of the system 100. The user interface of the application may be designed to be responsive and user-friendly, enabling real-time interactions with AI models and other system functionalities. The web node 102 may operate as an independent instance, capable of processing user requests and routing them to the appropriate backend resources (e.g., shared resources) and/or remote resources (e.g., model provider). In response to processing and routing the request, the web node 102 may receive a response and display the response in a user-accessible format (e.g., a messaging thread). For scalability and fault tolerance, multiple web nodes 102-106 can be deployed as a cluster. A load balancer may distribute incoming requests from user devices across the web nodes 102-106, optimizing performance and preventing any single web node from becoming a bottleneck. This configuration also provides redundancy so that if one web node fails, others can continue to serve user requests without interruption.

The web nodes 102-106 may be or may include server environments capable of hosting a web application. This may include a rack-mounted server, desktop, or other physical or virtual electronic device configured to run a web server (e.g., Nginx or Apache) and host the application. The web nodes 102-106 may be stateless, meaning they do not retain user-specific data locally between requests. Session data and other user-specific information may be stored in centralized, shared databases. The stateless design may enhance flexibility, allowing users to interact seamlessly with the system 100 even when their requests are routed through different web nodes during a session.

The shared resources 108 are centralized components that support the operational efficiency, consistency, and scalability of the system 100. The shared resources 108 are shared across multiple web nodes 102-106, providing a unified backbone that enables seamless communication and data processing. The shared nature allows the web nodes 102-106 to have access to the same pool of functionalities and data, regardless of their individual configurations or physical locations. The sharing of certain resources enables consistency and scalability. For example, a shared file store allows user-uploaded files to be accessible to each web node regardless of the web node to which they are uploaded. This avoids duplication of data and prevents situations where users interacting with different web nodes encounter inconsistent states. Similarly, shared databases may store session data, interaction records, and/or embeddings for retrieval-augmented generation (RAG) in a centralized manner. This allows users to experience a unified interaction flow, even when requests are distributed across multiple nodes by a load balancer. The shared resources 108 in the system 100 include the file store 110, vector database 112, data extraction server 116, and proxy service 114.

The shared resources 108 may include hardware and/or software configured to host a file store 110. A file store 110 provides a centralized repository for documents and other files, which may be uploaded by users via a web node 102. The file store 110 allows data uploaded by a user to web node 102 to be accessible across other nodes 104-106, reducing redundancy and synchronization issues. The file store 110 may also act as a common storage solution for session data, chat logs, etc. The file store 110 may facilitate the maintenance of consistency across web nodes 102-106, allowing user interactions to be cohesive regardless of which node 102-106 handles their subsequent requests.

The shared resources 108 may also include hardware and/or software configured to host a vector database 112. A vector database 112 manages embeddings for retrieval-augmented generation (RAG). Using tools such as ChromaDB, this component facilitates efficient retrieval and contextualization of information stored as vector embeddings, which may be used for enhancing the relevance and accuracy of AI-generated responses.

The shared resources 108 may also include hardware and/or software configured to host a proxy service 114. The proxy service 114, using tools like LiteLLM, may act as an intermediary between the internal network and AI model providers 120-126 remote from the internal network (e.g., in an external network). The proxy service 114 emulates standardized endpoints, such as an API for a particular model provider 120, and translates requests (e.g., from web nodes 102-106) into provider-specific formats. This translation capability allows the system 100 to integrate with a diverse range of AI models, adapting to their API specifications without requiring changes to the web nodes or user interfaces.

The shared resources 108 may also include hardware and/or software configured to host a data extraction server 116. The data extraction server 116, using tools like Apache Tika, may convert various file formats, such as PDFs and Word documents, into plain text. This transformation may be used for presenting document contents to AI models, enabling the AI models to process and analyze user-provided data effectively.

External to the system 100 is one or more model providers 120-126. Model providers 120-126 may be external organizations that host AI models capable of performing a wide range of tasks, including natural language understanding, content generation, data analysis, and/or the like. By utilizing model providers 120-126, the system 100 can leverage certain AI models without the need to host or maintain the resource-intensive infrastructure required to run such models locally. Accessing model providers 120-126 may include establishing a connection to them via their APIs. Each model provider 120-126 defines their own communication protocol (e.g., request and response format), which may include details such as the input data, model parameters, and authentication tokens. To use a model, the system 100 may send a request to the model provider 126 (e.g., the model provider's API endpoint), including any required inputs and configuration settings. The model provider 126 may process the input using its AI model and return the result in the model provider's specified format.

In some embodiments, the system 100 may communicate with an orchestrator 118 to access certain model providers 120-122. An orchestrator 118 (e.g., AWS Bedrock) may be an aggregation and management layer for AI model providers 120-122. The orchestrator 118 may provide a unified and managed interface to access multiple models from various providers, simplifying integration with the system 100. The orchestrator 118 may abstract the complexity of interacting with different APIs by offering a unified API and/or set of resources (e.g., licenses, compute, etc.) that developers can use to access certain models. However, the orchestrator 118 does not translate between different API formats. Instead, they provide access to a curated list of models that already conform to their interface requirements and can be provided under collective agreements (e.g., license agreements). For instance, AWS Bedrock supports models from select providers, but those providers must implement compatibility with the Bedrock API for their models to be included. In other words, AWS Bedrock does not transform requests or responses into formats required by providers outside its supported ecosystem.

The proxy service 114 in the system 100 fills a different and more flexible role than the orchestrator 118. The proxy service 114 acts as a dynamic translator between the standardized format used by the internal network and the specific requirements of various external model providers 120-126. This includes resolving differences in request formatting, authentication methods, and response parsing. For example, the proxy service 114 can take a request compatible with model provider 124 (whose communication protocol may be the standard for the system 100) and translate it into the format required by model provider 126 that does not natively support the API format of model provider 124. This translation capability enables compatibility with model providers that do not conform to the standard communication protocol of the system 100, enabling a broader and more customizable integration of a model provider.

In some embodiments, the system 100 may include hardware and/or software configured to host one or more load balancers. The load balancers may distribute (e.g., evenly) user requests across the web nodes 102-106, optimizing resource utilization and maintaining high availability. The load balancer may operate on a per-request basis, meaning it can dynamically redirect traffic to the least-burdened web node in real-time, which enables responsiveness and reliability even under heavy loads. The system 100 may also or instead include load balancers that distribute translated requests from the proxy service 114 across model providers 120-126 and/or the devices (e.g., servers) thereof. For example, if a user is not particular about which model provider to use (e.g., when multiple model providers allow access to the same type of model), the load balancer may forward translated requests from one model provider over to another if the other model provider has greater availability to handle the user's request.

It should be understood that the file store 110, vector database 112, proxy service 114, and data extraction server 116 are merely example shared resources 108 and that the system 100 may find use with greater or fewer than four shared resources.

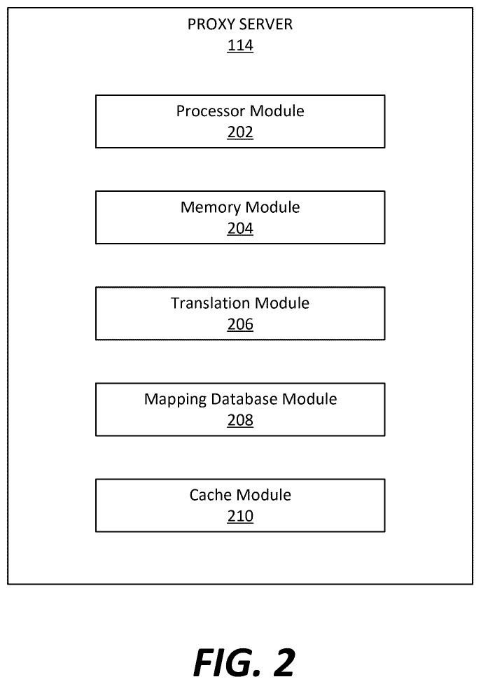

FIG. 2 is a diagram of an example proxy service 114 of the system 100, in accordance with one or more embodiments. Not all of the depicted components may be used in all embodiments, and one or more embodiments may include additional, fewer, or different components than those shown in the figure. Variations in the arrangement and type of components may be made without departing from the spirit or scope of the claims as set forth herein.

The proxy service 114 is an intermediary system (e.g., server) configured to facilitate communication between a client (e.g., a web node 102) and a server (e.g., a model provider 124) by serving as a translator, mediator, and/or optimizer in data exchanges. Particularly, the proxy service 114 may translate requests and responses between the standardized format of the internal network and the specific formats required by external model providers 120-126. To accomplish this, the proxy service 114 incorporates a variety of modules that may include hardware and/or software to accomplish particular functionality.

The proxy service 114 includes a processor module 202. This processor module 202 may be responsible for orchestrating the execution of various operations so that each request is routed through the appropriate modules for processing (e.g., process 400 described below). For example, the proxy service 114 manages the flow of requests and responses through the system 100. The processor module 202 acts as the command center, maintaining synchronization and optimizing the sequence of operations, such as translation, mapping, and/or caching.

The proxy service 114 may also include a memory module 204. The memory module 204 may include temporary storage for data such as active requests, responses, and/or intermediate data. The memory module 204 may be used for handling concurrent user interactions, enabling the proxy service 114 to maintain context and state as multiple tasks simultaneously are processed simultaneously. The memory module 204 allows the proxy service 114 to manage tasks efficiently, particularly when handling large volumes of data or complex requests that may require extended processing time.

The proxy service 114 may also include a mapping database module 208. The mapping database module 208 maintains a repository of rules, templates, and/or configurations that define how different APIs should be translated from one to another. This module 208 may act as a knowledge base for the proxy service 114, storing details about API endpoints, parameter mappings, authentication methods, and/or other protocol-specific requirements. By referencing this module 208, the translation module 206 can adapt to the nuances of various external providers dynamically.

The proxy service 114 may also include a translation module 206. The translation module 206 converts network traffic (e.g., requests, API calls, etc.) between communication protocols (e.g., data formats). When a request is received from a web node, the translation module 206 may reformat it into the protocol required by the target external model provider. For example, if a request follows an API format (which is the standard for the system 100) and is to be sent to a model provider that uses another format, the translation module 206 applies the necessary transformations to conform the request to the other format. Similarly, when a response is received from an external model provider, the module 206 translates it back into the standardized format expected by the web node.

In some embodiments, the proxy service 114 maps field names from the source format to the target format. For instance, consider an API request formatted for Provider A, which uses the field name “text_input” for the user query. If the target provider, Provider B, expects this data under the field name “prompt”, the proxy service 114 refers to its mapping database module 208, which contains a predefined mapping for this transformation. When processing the request, the proxy service 114 renames the “text_input” field to “prompt” for compatibility with Provider B's API. Similarly, when Provider B returns a response with a field named “generated_text”, the proxy service may map this back to “response” to conform to the source node's expectations.

In some embodiments, the proxy service 114 adapts the structure of the data itself, which may differ between APIs. Suppose Provider A expects user preferences to be included as a JSON object within the request body, such as:

```
{
  “user_id”: “12345”,
  “preferences”: { “language”: “en”, “tone”: “formal” }
}
```

However, Provider B requires these preferences as top-level fields:

```
{
  “user_id”: “12345”,
  “language”: “en”,
  “tone”: “formal”
}
```

The translation module 206 may identify this discrepancy and reconstruct the data format by extracting the nested preferences object and promoting its fields to the top level. The mapping database module 208 may specify these transformations so that the restructured data adheres to Provider B's API specifications.

In some embodiments, the translation module 206 adapts authentication credentials. Provider A might require an API key passed in the request headers: Authorization: abc123

Meanwhile, Provider B might expect the same API key to be included as a query parameter:

POST/endpoint?api_key=abc123

The translation module 206 may translate the authentication method by extracting the key from the authorization header and appending it as a query parameter to the request URL. The mapping database module 208 may include the rules for these authentication translations enabling secure and seamless communication across model providers.

In some embodiments, the translation module 206 also considers the different types of parameters accepted by the various model providers. For example, Provider A might use a string to represent a numerical parameter:

{“confidence”: “0.95”}

Whereas Provider B expects a floating-point number:

{“confidence”: 0.95}

The translation module 206 may detect the expected data type based on the mappings in the database module 208 and automatically convert the value from a string to a number. This ensures the request is correctly interpreted by Provider B.

In some embodiments where the API endpoints themselves differ, the translation module 206 modifies the URL path based on predefined mappings. For example, if Provider A uses a/generate endpoint and Provider B uses/create-text, the translation module 206 translates the requested endpoint path accordingly.

In some embodiments, the translation module 206 enriches a request with additional data and/or filters out unnecessary fields. For example, if Provider A requires metadata fields like “session_id” and “timestamp” to be included in the request but the internal system does not provide them, the proxy service 114 may dynamically inject these values based on predefined rules. Conversely, if Provider B has strict requirements to exclude certain sensitive fields, the proxy service 114 filters out those fields during translation.

In some embodiments, in addition to translating requests, the translation module 206 can also adjust response formats. For instance, if Provider A returns a flat JSON object:

{“status”: “success”, “data”: “Hello, world!”}

And the internal system expects a more structured response:

{“response”: {“status”: “success”, “content”: “Hello, world!”}}

The translation module 206 restructures the response data accordingly so that the request is received in the required format.

In some embodiments, if the second format includes additional parameters than the first format, the translation module 206 may generate values for the additional parameters based on the values associated with the parameters of the received request. Similarly, if the second format includes fewer parameters than the first format, the translation module 206 may consolidate the values of one or more of the parameters of the received request.

While the translation module 206 may utilize predefined rules for performing the translation, the translation module 206 of a proxy service 114 may also or instead utilize machine learning (ML) to dynamically adapt to new formats or changes in existing formats (e.g., for API requests). This capability may enhance the flexibility and scalability of the proxy service 114 by reducing reliance on predefined mappings and enabling it to respond autonomously to evolving integration requirements.

APIs may undergo updates, introducing new fields, modifying existing structures, or changing parameter types. An ML-based translation module 206 could analyze patterns in incoming and outgoing data to infer how API formats have changed. For instance, using natural language processing (NLP) or unsupervised learning techniques, the module 206 could detect relationships between similar fields and/or identify mapping equivalencies based on semantic similarities between field names and descriptions. When an API update occurs, the module 206 could generate potential translation mappings by identifying analogous fields in the updated schema. For example, if a parameter “confidence” is renamed to “certainty” in a new version of an API, an ML model trained on historical API formats and field usage could recognize the semantic similarity and automatically update the mapping without human intervention.

In some embodiments, ML models, including those designed for format matching, could analyze API formats to generate mappings dynamically. Techniques like entity resolution, semantic similarity scoring, and/or clustering could help the translation module 206 establish correspondences between fields in different API formats. For example, ML algorithms could analyze metadata, field descriptions, and/or example data types to suggest or implement mappings between formats from different model providers or API versions.

In some embodiments, ML models could be used to monitor API interactions and detect anomalies indicative of changes in API formats. For instance, if a previously valid request starts failing or produces unexpected results, anomaly detection models could flag the issue and attempt to identify discrepancies between the expected and actual responses. This insight could prompt the translation module 206 to adapt its mappings and/or notify administrators of the need for intervention.

In some embodiments, reinforcement learning could be utilized to refine the translation process over time. The translation module 206 could evaluate the success of different translation strategies based on feedback, such as response correctness, latency, and/or error rates. By iteratively improving its decision-making, the module 206 could learn to handle variations in API formats or ambiguous mappings more effectively. For example, when interacting with an unfamiliar API format, the module 206 may experiment with different mappings and evaluate the responses to determine the most accurate mapping. Over time, the module 206 could generalize from these experiences to handle similar situations more efficiently.

In some embodiments in which APIs handle multimodal data (e.g., combining text, images, and structured data), machine learning models designed for multi-modal tasks could assist in translation. For example, APIs handling image analysis might use different conventions for image encoding or metadata structures. An ML-based translation module 206 could analyze data relationships across formats and learn to perform transformations that preserve the semantic integrity of the input.

In some embodiments, ML models may utilize API documentation and update notes to stay aligned with format changes. The module 206 may also use NLP techniques to parse documentation, infer field meanings, and/or detect format changes, which the module 206 could incorporate into its translation mappings.

Although the foregoing embodiments were described with respect to translating requests from the web nodes, similar techniques may be utilized to translate responses from the model providers.

The proxy service 114 may also include a cache module 210. The cache module 210 may enhance the efficiency of the proxy service 114 by storing frequently used responses and data. For example, if multiple users request similar information or outputs from a model provider, the proxy service 114 can serve the cached response instead of issuing a new request. This reduces latency, minimizes the load on model providers, and optimizes resource usage within the system 100. The cache module 210 may also support time-to-live (TTL) settings so that cached data does not become stale.

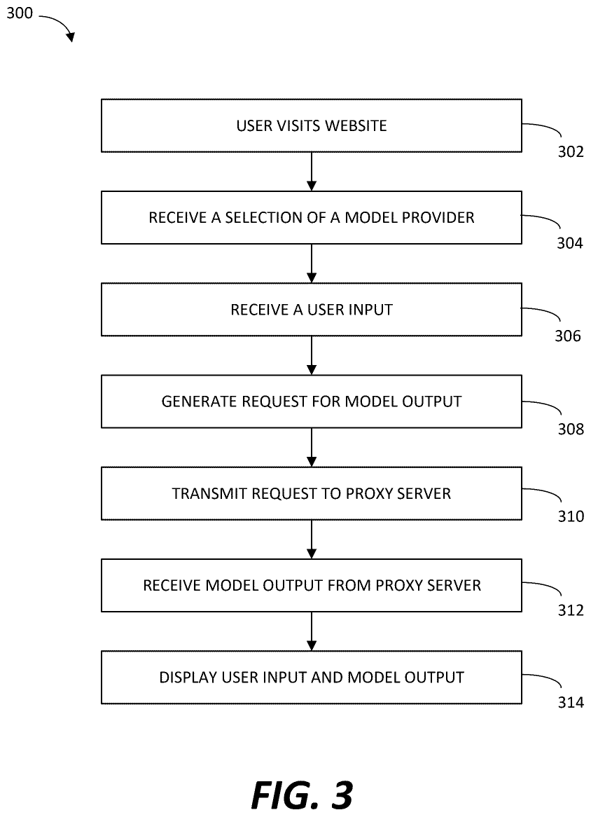

FIG. 3 is a flow diagram of an example process 300 for communicating with a proxy service, in accordance with one or more embodiments. For explanatory purposes, FIG. 3 is described herein with reference to the system 100 of FIG. 1, and thus the process 300 may be a computer-implemented method. However, this is merely illustrative, and features of the system 100 may be performed by any other system for implementing the subject technology. Additionally, for explanatory purposes, the operations of the process 300 are described herein as occurring sequentially or linearly. However, multiple operations of the process 300 may occur in parallel. The operations of the process 300 need not be performed in the order shown, and one or more operations of the process 300 need not be performed or can be replaced by other operations.

An end-to-end example of the system 100 in operation begins with a user interacting with the web-based interface hosted by the web node (e.g., web node 102).

At operation 302, the user visits a website hosted by the web node, which serves as the entry point for the system 100. This website may provide a responsive and interactive user interface, typically including features such as a chat window, model selection options, and/or input fields for user queries. For instance, a researcher might access the website of the web node to generate a summary of a scientific paper or ask a specific question about a dataset.

At operation 304, once the user is on the website, the user selects a desired model provider (e.g., a model type associated with a model provider) from a list of options presented on the user interface. These options might include well-known providers or other integrated models available through the system 100. The selection process may involve choosing from a dropdown menu, clicking a button, and/or using predefined criteria such as cost, performance (e.g., latency), and/or model modality. For example, a user working on a coding project might opt for a model that excels in technical query handling, while another user might prefer a model optimized for creative content generation. The system 100 may dynamically update the interface to reflect the selected provider.

At operation 306, following the selection of the model provider, the user inputs their query to the web node via the user interface. This could take various forms, such as a typed question, a block of text to be analyzed, and/or an instruction specifying a task to be performed. For instance, a user might enter, “Summarize this article on climate”, or “Generate a Python script for a basic web scraper”. The web node receives the input and associates it with the chosen model provider, preparing the data for transmission to the appropriate model provider. The web node may validate that the input conforms to acceptable formats and standards, such as checking for proper syntax, removing invalid characters, and/or sanitizing inputs to prevent security risks like injection attacks. Throughout this phase, the web node may manage session states (e.g., chat sessions), capture user preferences, and/or verify that the selected model provider and user input are properly synchronized (e.g., via shared resources 108 such as the file store 110).

At operation 308, the web node generates an API request based on the user input and formatted to conform to the standard formatting of the system 100. The request may include data such as the user's query, the selected model provider, and any metadata such as session identifiers or contextual parameters. The API request is then queued for transmission to the proxy service (e.g., proxy service 114), which bridges the internal components of the system 100 with external model providers (e.g., model providers 120-126).

At operation 310, the web node sends the request to the proxy service 114. Upon receiving the request, the translation module 206 of the proxy service 114 analyzes the contents of the request, referencing the mapping database module 208, to determine how to adapt the request for the selected model provider, if needed. If the provider expects specific field names, authentication headers, data structures, and/or the like, the translation module 206 dynamically reconfigures the request to meet those requirements. For example, if the system 100 format refers to the user query as “text_input” but the model provider requires it as “prompt”, the proxy service 114 makes this adjustment. In some embodiments, translating the request to a format associated with a particular model provider is in response to the request being addressed to the particular model provider.

Once translated, the proxy service 114 forwards the request to the selected model provider's API endpoint, where an AI model processes the query. The model provider processes the request to generate a response (e.g., a model output) based on the user's input. This response (e.g., in JSON or another structured format) is sent back to the proxy service 114. In forwarding the response to the web node, the proxy service 114 may apply a reverse translation, converting the provider's response (which includes the model output) into the standardized format used by the system 100. This enables the web node to handle the data consistently, regardless of which external provider produced it, without increasing the computational load of the web node.

At operation 312, the web node receives the processed response from the proxy service. The response may include the model output alongside any additional information, such as metadata or usage statistics. The web node may integrate this data with the user's session so that it aligns with the context of the user's interaction. For instance, if the response is a generated text snippet, the web node formats it for display so it can be a visually coherent chat message response. The web node may also perform additional transformations, such as truncating responses greater than a threshold length or converting the response into rich text for enhanced readability.

At operation 314, the web node updates the user interface to display both the input provided by the user and the corresponding output generated by the model. This enables a conversational experience where the user can view their original query alongside the model provider's response in a chat-like format. For example, a user who asked for a summary of an article would see their question followed by the concise summary produced by the model of their choosing. The interface may also include options for the user to refine their query, request further details, or select a different model provider for another response.

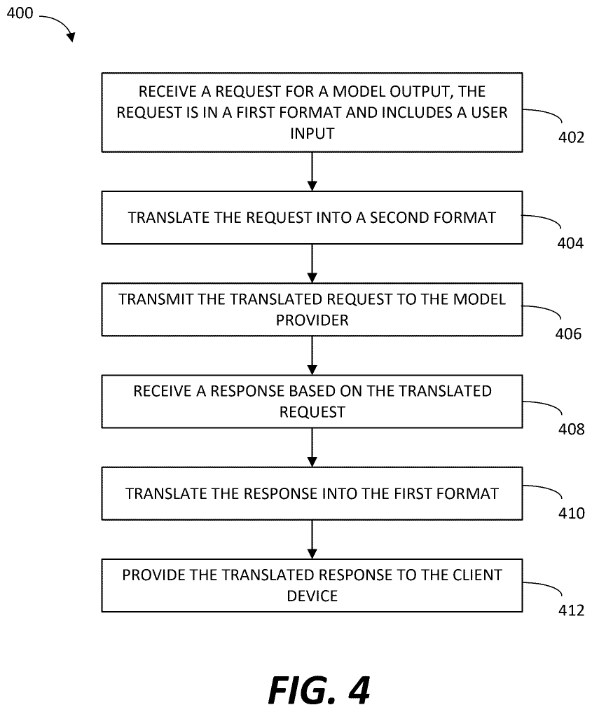

FIG. 4 is a flow diagram of an example process 400 for proxying communication with a model provider, in accordance with one or more embodiments. For explanatory purposes, FIG. 4 is described herein with reference to the system 100 of FIG. 1, and thus the process 400 may be a computer-implemented method. In some embodiments, some or all of the process 400 may be performed by the proxy service 114. However, description of the process 400 with reference to the components of system 100 is merely illustrative, and features of the system 100 may be performed by any other system for implementing the subject technology. Additionally, for explanatory purposes, the operations of the process 400 are described herein as occurring sequentially or linearly. However, multiple operations of the process 400 may occur in parallel. The operations of the process 400 need not be performed in the order shown, and one or more operations of the process 400 need not be performed or can be replaced by other operations.

At operation 402, the service (e.g., proxy service 114) receives a request for a model output. The request is received from a web node. The request may be in a first format (e.g., a standard format for the system 100) and include elements such as the user input (e.g., from a client device in communication with the web node), metadata about the session or input, and/or identifiers specifying the target model provider. In some embodiments, the first format may be associated with a model provider. This way, some requests do not need to be translated as they are already in the proper form for at least one model provider. Upon receipt, the proxy service parses the request to extract the elements of the request, using the processor module (e.g., processor module 202) to provide proper routing and compatibility with subsequent operations.

At operation 404, the service translates the request into a second format (e.g., a format compatible with the target model provider). In some embodiments, the translation module (e.g., translation module 206) may analyze the incoming request, referencing predefined rules in the mapping database (e.g., mapping database module 208) to determine how each field and parameter should be adapted to match the format of the target provider. For example, if the first format labels the user input field as “text_input” but the external provider expects it as “prompt”, the translation module substitutes the field name accordingly. Similarly, if the model provider requires additional fields, such as an authentication token (e.g., API key associated with the model provider) or specific headers for the request, the translation module dynamically injects these elements into the request. Complex transformations, such as restructuring nested JSON objects or converting data types, are also handled during this phase to ensure that the translated request adheres to the format utilized by the selected model provider.

In some embodiments, translating the received request into the second format includes parsing the request to identify parameters associated with the first format and to identify values associated with the identified parameters. The identified parameters may be mapped to corresponding parameters associated with the second format. A translated request comprising parameters associated with the second format may be generated. The parameters of the translated requested may be associated with the identified values according to the mapping.

In some embodiments, translating the received request into the second format includes parsing the request to identify parameters associated with the first format and mapping the identified parameters to corresponding parameters associated with the second format. The identified parameters of the request may be mapped to match the corresponding parameters according to the mapping.

In some embodiments, the request from the web node is translated in parallel with the other request from the web node and/or one or more other web nodes.

At operation 406, once the translation is complete (if needed), the proxy service sends (e.g., transmits) the translated request to the target model provider. The proxy service may establish a secure connection to the model provider's API endpoint (e.g., using HTTPS or another encrypted protocol) to protect the data in transit. The proxy service may confirm that the request meets the model provider's protocol requirements, such as including appropriate authentication tokens or complying with rate limits. For instance, if the model provider imposes restrictions on request frequency, the proxy service may implement rate-limiting mechanisms to avoid exceeding allowable thresholds. The translated request, now aligned with the provider's API expectations, is then sent, initiating the processing of the user's query by the external AI model.

In some embodiments, the user may not select a particular model provider. In which case, sending the translated request includes selecting a model provider. The selection may be based on the availability of the model providers. For example, the selection may be based on which model provider has an optimal availability (e.g., below a threshold level of load) to handle the request.

In some embodiments, the model provider includes one or more electronic devices (e.g., API endpoints) and sending the translated request includes selecting a model provider device to which the request is sent. The selection may be based on a load balancing algorithm, which may be a function of variables such as a current load of each device, a response time of each device, a geographic location of each device, and/or any other attribute of each device. Once selected, the proxy service may forward the request to the selected model provider device.

At operation 408, the proxy service receives the response from the model provider. The response is generated by the model provider based on the translated request and is formatted according to the model provider's specific formatting (e.g., API structure). For example, if the user requested a summary of a document, the response might include a JSON object with fields such as “summary” or “output_text”. The proxy service may validate and/or parse the response so that it aligns with the expected format and contains all the necessary elements. If any inconsistencies or errors are detected (e.g., such as missing fields or incorrect data types), the proxy service may initiate error handling procedures, which may include generating fallback responses or requesting additional information from the provider.

At operation 410, the proxy service translates the model provider's response back into the standardized format used by the system 100. This reverse translation is handled by the proxy service's translation module, which references the mapping database module that was used during the initial request translation (operation 404). The translation module identifies the required transformations to adapt the provider-specific fields, structures, and/or values into the system 100 format. For instance, if the model provider's response uses the field “output_text” to convey the model's result but the system 100 expects this data under the field “response”, the proxy service renames the field accordingly. Similarly, additional metadata from the model provider, such as processing time or token usage, can be reformatted or filtered out based on the specifications of the standard format of the system 100. The reverse translation process may also involve restructuring complex responses. For example, if the model provider returns nested data objects and/or includes extraneous fields, the proxy service may simplify (e.g., consolidate) and/or organize the data into a particular data structure. This allows the web nodes to process and display the response without fewer adjustments or compatibility issues.

At operation 412, the proxy service sends the translated response to the client device of the user (e.g., through the web node that initiated the request). The response is sent using the internal network protocols of the system 100 for secure and efficient delivery. Once the web node receives the response, the proxy service integrates the response data with the user's session and prepares the response data for display.

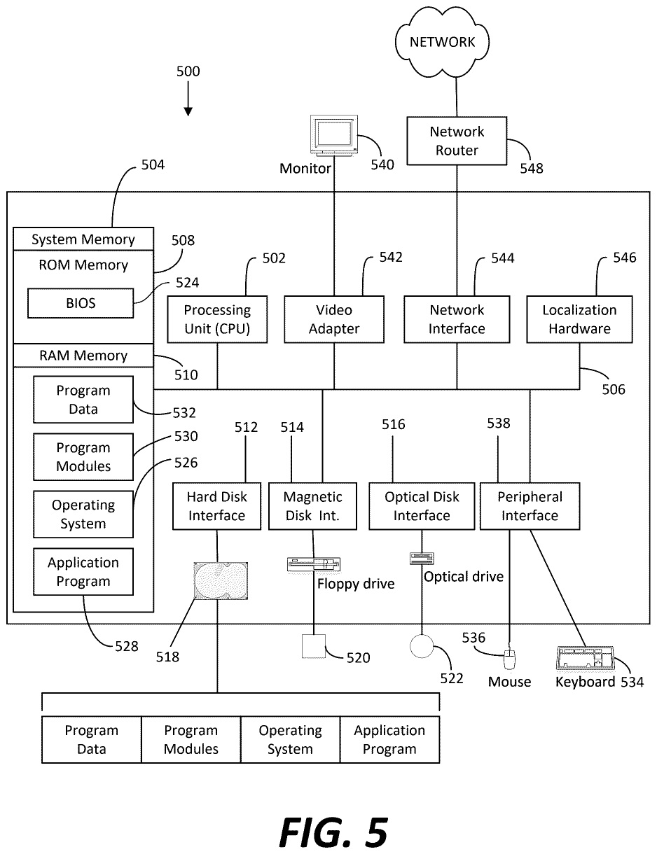

FIG. 5 is a block diagram of an example computing system 500. A computing system 500 may be a desktop computer, laptop, smartphone, tablet, or any other electronic device having the ability to execute instructions, such as those stored within a non-transitory computer-readable medium. Furthermore, while described and illustrated in the context of a single computing system 500, those skilled in the art will also appreciate that the various tasks described herein may be practiced in a distributed environment having multiple computing systems 500 linked via a local or wide-area network in which the executable instructions may be associated with and/or executed by one or more of multiple computing systems 500.

In its most basic configuration, the computing system 500 may include at least one processing unit 502 and at least one memory 504, which may be linked via a bus 506. Depending on the exact configuration and type of computing system environment, memory 504 may be volatile (such as RAM 510), non-volatile (such as ROM 508, flash memory, etc.) or some combination of the two.

Computing system 500 may have additional features and/or functionality. For example, computing system 500 may also include additional storage (removable and/or non-removable) including, but not limited to, magnetic or optical disks, tape drives and/or flash drives. Such additional memory devices may be made accessible to the computing system 500 by means of, for example, a hard disk drive interface 512, a magnetic disk drive interface 514, and/or an optical disk drive interface 516. As will be understood, these devices, which would be linked to the system bus 506, respectively, allow for reading from and writing to a hard drive 518, reading from or writing to a removable magnetic disk 520, and/or for reading from or writing to a removable optical disk 522, such as a CD/DVD ROM or other optical media. The drive interfaces and their associated computer-readable media allow for the non-volatile storage of computer-readable instructions, data structures, program modules and other data for the computing system 500. Those skilled in the art will further appreciate that other types of computer-readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer-readable instructions, data structures, program modules or other data. Any such computer storage media may be part of computing system 500.

A number of program modules may be stored in one or more of the memory/media devices. For example, a basic input/output system (BIOS 524), containing the basic routines that help to transfer information between elements within the computing system 500, such as during start-up, may be stored in ROM 508. Similarly, RAM 510, hard drive 518, and/or peripheral memory devices may be used to store computer executable instructions comprising an operating system 526, one or more applications programs 528, other program modules 530, and/or program data 532. Still further, computer-executable instructions may be downloaded to the computing system 500 as needed, for example, via a network connection. The applications programs 528 may include, for example, translation logic for a proxy service 114.

An end-user may enter commands and information into the computing system 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus 506. Input devices may be directly or indirectly connected to processing unit 502 via interfaces such as, for example, a parallel port, game port, firewire, or a universal serial bus (USB). To view information from the computing system 500, a monitor 540 or other type of display device may also be connected to bus 506 via an interface, such as via video adapter 542. In addition to the monitor 540, the computing system 500 may also include other peripheral output devices, not shown, such as speakers and printers.

The computing system 500 may also utilize logical connections to one or more computing system environments. Communications between the computing system 500 and the remote computing system environment may be exchanged via a further processing device, such a network router 548, that is responsible for network routing. Communications with the network router 548 may be performed via a network interface component 544. Thus, within such a networked environment, e.g., the Internet, wide area network (WAN), local area network (LAN), or other like type of wired or wireless network, it will be appreciated that program modules depicted relative to the computing system 500, or portions thereof, may be stored in the memory storage device(s) of the computing system 500.

The computing system 500 may also include localization hardware 546 for determining a location of the computing system 500. In embodiments, the localization hardware 546 may include, for example only, a GPS antenna, an RFID chip or reader, a Wi-Fi antenna, or other computing hardware that may be used to capture or transmit signals that may be used to determine the location of the computing system 500.

Referring to FIG. 1, the web nodes 102-106, shared resources 108, and/or model providers 120-126 may each be a computing system 500 including, for example, the processing unit 502, system memory 504, ROM 508, RAM 510, network interface component 544, and storage (e.g., hard disk drive interface 512).

While this disclosure has described certain embodiments, it is understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, the subject technology is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the subject technology.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining,” “outputting,” “transmitting,” “recording,” “locating,” “storing,” “displaying,” “receiving,” “recognizing,” “utilizing,” “generating,” “providing,” “accessing,” “checking,” “notifying,” “delivering,” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

1. A computer-implemented method comprising:
receiving, from a client device, a request for a model output, the request conforming to a first format associated with a first model provider, and the request including a user input;
translating the received request into a second format associated with a second model provider;
transmitting the translated request to the second model provider and receiving a response based on the translated request, the response including the model output from a model of the second model provider;
translating the received response into the first format associated with the first model provider; and
providing the translated response to the client device causing the client device to present the user input and the model output.

2. The computer-implemented method of claim 1, wherein translating the received request into the second format comprises:
parsing the request to identify parameters associated with the first format and to identify values associated with the identified parameters;
mapping the identified parameters to corresponding parameters associated with the second format; and
generating a translated request comprising parameters associated with the second format, the parameters of the translated requested being associated with the identified values according to the mapping.

3. The computer-implemented method of claim 1, wherein translating the received request into the second format comprises:
parsing the request to identify parameters associated with the first format;
mapping the identified parameters to corresponding parameters associated with the second format; and
modifying the identified parameters of the request to match the corresponding parameters according to the mapping.

4. The computer-implemented method of claim 1, wherein the second model provider comprises one or more second model provider devices, and transmitting the translated request comprises:
selecting a second model provider device of the one or more second model provider devices based on a load balancing algorithm, wherein the load balancing algorithm considers at least one of a current load of each server, a response time of each server, and a geographic location of each server; and
forwarding the request to the selected second model provider device.

5. The computer-implemented method of claim 1, further comprising:
receiving, from the client device, another request for another model output, the other request conforming to a first format associated with a first model provider and comprising another user input;
translating the other request into a third format associated with a third model provider, in response to the other request being destined for the third model provider;
transmitting the other request to the third model provider and receiving a response in response to the other request, the response including the other model output from a model of the third model provider;
translating the received response into the first format associated with the first model provider; and
providing the translated response to the client device causing the client device to present the other user input and the other model output.

6. The computer-implemented method of claim 1, further comprising:
receiving, from another client device, a request for a model output, the request conforming to a first format associated with a first model provider and comprising a user input;
translating the received request into a second format associated with a second model provider, in response to the received request being destined for the second model provider;
transmitting the translated request to the second model provider and receiving a response in response to the translated request, the response including the model output from a model of the second model provider;
translating the received response into the first format associated with the first model provider; and
providing the translated response to the other client device causing the other client device to present the user input and the model output.

7. The computer-implemented method of claim 6, wherein the request from the client device is translated in parallel with the other request from the other client device.

8. The computer-implemented method of claim 1, wherein translating the received request into the second format associated with the second model provider comprises embedding an authentication token associated with the second model provider.

9. The computer-implemented method of claim 1, wherein translating the received request into the second format associated with the second model provider is in response to the received request being addressed to the second model provider.

10. The computer-implemented method of claim 1, further comprising, before translating the received request into the second format associated with the second model provider, selecting the second model provider from a set of model providers based on at least one of modality of the user input, cost of the model output, and latency of the second model provider.

11. A computing system comprising:
a processor; and
a non-transitory computer-readable medium storing instructions that, when executed by the processor, cause the computing system to perform operations comprising:
receiving, from a client device, a request for a model output, the request conforming to a first format associated with a first model provider, and the request including a user input;
mapping parameters of the received request to a second format associated with a second model provider;
transmitting the mapped request to the second model provider and receiving a corresponding response, the response including the model output;
mapping parameters of the received response to the first format; and
returning the received response to the client device for displaying the user input and the model output.

12. The computing system of claim 11, wherein mapping the parameters of the received request comprises resolving differences in at least one of parameters names, data structures, or request configurations.

13. The computing system of claim 11, wherein mapping the parameters of the received request comprises modifying one or more of a formatting or metadata of the received request based on the second format.

14. The computing system of claim 11, wherein transmitting the mapped request to the second model provider is responsive to determining that a current load of the second model provider is less than a current load of a third model provider.

15. The computing system of claim 11, wherein the operations in a first instance are performed in parallel with the operations in a second instance, the client device in the first instance is a first client device, and the client device in the second instance is a second client device different from the first client device.

16. The computing system of claim 11, wherein the second format includes additional parameters than the first format, and mapping the parameters of the received request to the second format comprises generating values for the additional parameters based on values associated with the parameters.

17. The computing system of claim 11, wherein the second format includes fewer parameters than the first format, and mapping the parameters of the received request to the second format comprises consolidating values of one or more of the parameters.

18. A non-transitory computer-readable medium storing instructions that, when executed by a processor of a computing system, cause the computing system to perform operations comprising:
receiving, from a client device, a request for a model output in a client session, the request conforming to a first communication protocol associated with a first model provider, and the request including a user input and associated session metadata;
translating the request into a second communication protocol associated with a second model provider;
transmitting the request to the second model provider and receiving a corresponding response, the response including the model output generated by a model of the second model provider;
translating the response into the first communication protocol, including retaining and/or reconstructing session metadata for continuity of the client session; and
transmitting the response to the client device for rendering the user input and the model output in context of the client session.

19. The non-transitory computer-readable medium of claim 18, wherein:
the operations in a first instance are performed in parallel with the operations in a second instance;
the client device in the first instance is a first client device; and
the client device in the second instance is a second client device different from the first client device.

20. The non-transitory computer-readable medium of claim 18, wherein translating the request into the second communication protocol comprise:
in response to determining that the second communication protocol includes additional fields than the first communication protocol, mapping fields of the request to the second communication protocol comprises generating values for the additional fields based on values associated with the fields of the request; and
in response to determining that the second communication protocol includes fewer fields than the first communication protocol, mapping the fields of the request to the second communication protocol comprises consolidating values of one or more of the fields.
